(19) United States
(12) Patent Application Publication
(10) Pub. No.: US 2004/0224175 A1
(43) Pub. Date: Nov. 11, 2004

(54) Multilayered film

(76) Inventor: Kevin O. Henderson, Willoughby Hills, OH (US)

Correspondence Address: Heidi A. Boehlefeld, Renner, Otto, Boisselle & Sklar, LLP, Nineteenth Floor, 1621 Euclid Avenue, Cleveland, OH, 44115-2191, US

(21) Appl. No.: 10/835,041

(22) Filed: Apr. 29, 2004

Related U.S. Application Data
(60) Provisional application No. 60/466,985, filed on May 1, 2003.

(51) Int. Cl. B32B 27/08

(52) U.S. Cl. 428/515; 428/500

(57) ABSTRACT

This invention relates to a multilayer film for use as in-mold labels, comprising a core layer having an upper surface and a lower surface; a skin layer overlying the upper surface of the core layer; a heat activatable layer bonded to the lower surface of the core layer by a tie layer; wherein the core layer comprises a blend of a propylene homopolymer and at least one polyterpene and wherein the multilayer film is oriented in the machine direction only and heat set.

This application claims the benefit of provisional patent application Serial No. 60/466,985 filed May 1, 2003, and is hereby incorporated by reference in its entirety.

### TECHNICAL FIELD

This invention relates to multilayered films and, more particularly, to multilayered films that are useful in making in-mold labels. Labels of this type are referred to as “in-mold” labels because the labels are held in place within the mold that forms the container during the container-forming process.

### BACKGROUND OF THE INVENTION

Polymeric in-mold labels offer many aesthetic and functional advantages over paper labels in the labeling of containers made from polymeric resins using blow-molding, injection molding or injection blow-molding. When a plastic container such as a high density polyethylene (HDPE) squeeze bottle is used to package a product such as hair shampoo, a package using a polymeric label is generally more appealing to consumers than a package using a paper label. In many applications the use of polymeric in-mold labels is required for reasons of appearance, handling, performance, moisture-resistance, conformability, durability and compatibility with the container to be labeled. Polymeric in-mold labels also enable clear or substantially transparent labels with only the label indicia being visible to the consumer.

In-mold labeling procedures, however, are not without their own difficulties. For example, in-mold labeling is known to have problems with distortion of the label. Distortion is caused by using a construction material that is chemically different from the substrate. Distortion also can be caused by the pressure and the melting points of the material. Another problem observed in in-mold labeling is blistering of the label. Blisters can be caused by trapped air or by insufficient initial adhesion to the container.

The in-mold label and labeling method of the present invention eliminates or reduces at least some of these problems by initially adhering the label to the container, reducing distortion and blistering of the label.

### SUMMARY OF THE INVENTION

This invention relates to a multilayer film for use in making an in-mold label and to molded plastic articles having an in-mold label as described herein. In one embodiment of the invention, the multilayer film comprises a core layer having an upper surface and a lower surface; a skin layer overlying the upper surface of the core layer; a heat activatable layer bonded to the lower surface of the core layer by a tie layer; wherein the core layer comprises a blend of a propylene homopolymer and at least one polyterpene and wherein the multilayer film is oriented in the machine direction only and heat set.

In one aspect of the invention, the polypropylene homopolymer of the core layer comprises a nucleated polypropylene homopolymer having a melt flow rate of at least 8 g/10 min.

In another aspect of the invention, the thickness of the heat activatable layer is about 20% of the overall thickness of the multilayer film.

In yet another aspect of the invention, the core layer blend of polypropylene homopolymer and polyterpene comprises about 50% to about 80% by weight of polypropylene homopolymer and about 20% to about 50% by weight of polyterpene, based on the weight of the polypropylene homopolymer and polyterpene.

### BRIEF DESCRIPTION OF THE DRAWINGS

FIG. 1 is a schematic illustration of the side view of a multilayered film embodying the present invention in a particular form.

FIG. 2 is a flow diagram illustrating a co-extruding, stretching, and annealing line used to make the inventive multilayered film.

FIG. 3 is a diagrammatic representation of a printing, cutting and stacking line used in making the inventive in-mold labels.

FIG. 4-7 diagrammatically illustrate the die cutting of the inventive in-mold labels to form stacks of labels.

FIG. 8 diagrammatically illustrates the use of the stacked labels in a molding operation.

### DETAILED DESCRIPTION OF THE INVENTION

The term “overlies” and cognate terms such as “overlying” and the like, when referring to the relationship of one or a first layer relative to another or a second layer, refers to the fact that the first layer partially or completely lies over the second layer. The first layer overlying the second layer may or may not be in contact with the second layer. For example, one or more additional layers may be positioned between the first layer and the second layer.

The term “high density polyethylene” or “HDPE” refers to a polyethylene having a density of about 0.940 to about 0.965 g/cc. The term “LLDPE” or “linear low density polyethylene” refers to a polyethylene having a density of about 0.850 to about 0.925 g/cc.

The term “service temperature of the label” is the temperature of the label when used as an in-mold label while in the mold for making a polymeric container. The service temperature of the label may range from about 200° F. (93.3° C.) to about 290°F. (1 43.3° C.), and in one embodiment about 200°F. (93.3° C.) to about 260°F. (126.7° C.), and in one embodiment about 220° F. (104.4° C.) to about 260° F. (126.7° C.).

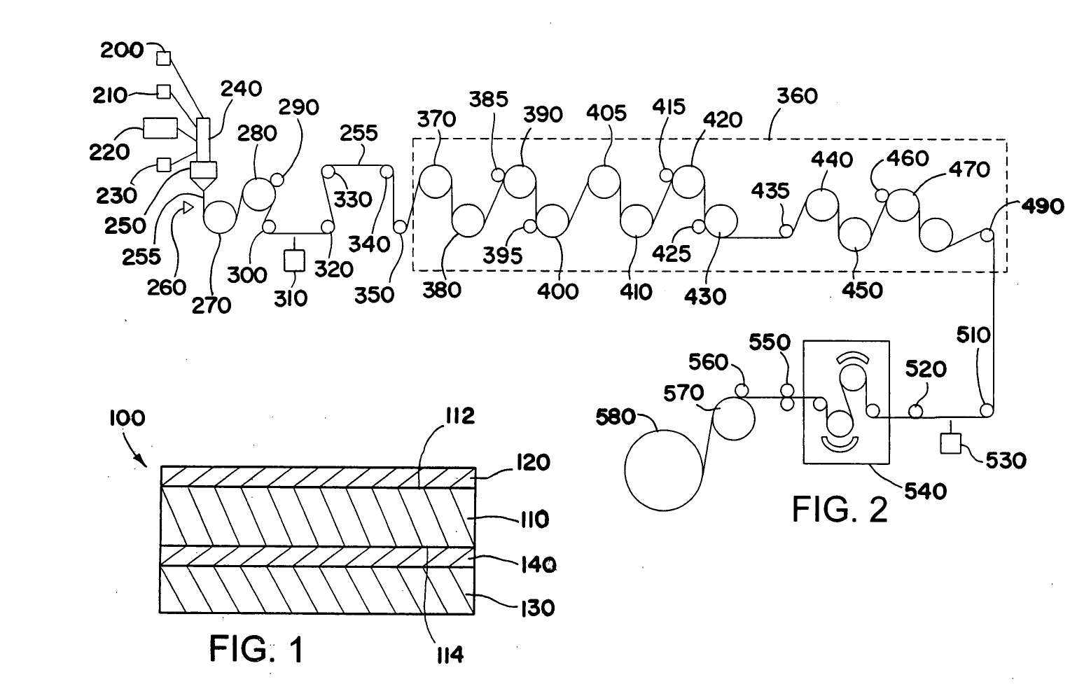

Referring to FIG. 1, the inventive multilayered film, in one of its illustrated embodiments, is generally indicated by the reference numeral 100, and is comprised of: a core layer 110 which has a first surface 112 and a second surface 114; and skin layer 120 overlying the first surface 112 of the core layer 110, a heat activatable layer 130 overlying the second surface 114 of the core layer, and a tie layer 140 positioned between the second surface 114 of the core layer 110 and the heat activatable layer 130.

The overall thickness of the multilayered film 100 may be in the range of about 2.5 to about 8 mils, and in one embodiment about 2.5 to about 4.5 mils, and in one embodiment about 3 to about 4.5 mils. The thickness of the core layer 110 may range from about 40% to about 80% of the overall thickness of the multilayered film 100, and in one embodiment about 45% to about 65%, and in one embodiment about 55% of the overall thickness of the film 110. The skin layer 120 may have a thickness of about 1 to about 25% of the overall thickness of the film 100, and in one embodiment 5 to about 20%, and in one embodiment about 15% of the overall thickness of the film 100. The heat activatable layer 130 may have a thickness equal to about 5 to 30% of the overall thickness of the film 100, and in one embodiment about 10 to 25%, and in one embodiment about 20% of the overall thickness of the film 100. Tie layer 140 may have a thickness equal to about 3 to about 15% of the overall thickness of the film 110, and in one embodiment about 7 to about 12%, and in one embodiment about 10% of the overall thickness of the film 100.

Core Layer

The core layer 110 may be comprised of a polypropylene resin having a high melt flow rate and a polyterpene resin. As used herein, the term “high melt flow rate” means that the melt flow rate is at least 8 g/10 min. In one embodiment, the polypropylene resin comprises a polypropylene homopolymer. An example of a commercially available nucleated polypropylene homopolymer that may be used is P4C5K-123A from Huntsman. This material is identified as having a melt flow rate of 20 g/10 min. (ASTM D1238), a density of 0.90 g/cm³ (ASTM D1505) and a flexural modulus of 1680 MPa (ASTM D790). Another example of a commercially available polypropylene homopolymer that may be used is Marlex® HGN-200 from Chevron Phillips Chemical Co. This material is identified as a nucleated polypropylene homopolymer having a melt flow rate of 20 g/10 min. (ASTM D1238), a density of 0.907 g/cm³ (ASTM D1505) and a flexural modulus of 1999 MPa (ASTM D790).

The polyterpene resin blended with the polypropylene resin provides improved stiffening action, increased modulus and increased strength of the resulting film. The polyterpene resins are a well-known class of resinous materials obtained by the polymerization or copolymerization of terpene hydrocarbons such as the alicyclic, mono-cyclic and bicyclic terpenes, and their mixtures, including carene, isomerised pinene, dipentene, terpinene, terpinolene, turpentine, a terpene cut or fraction, and various other terpenes.

The hydrogenated polyterpenes are also effective for improving the properties of the films. These are produced by hydrogenating the polyterpenes by any of the usual hydrogenation processes. Generally the hydrogenation is carries out utilizing a catalyst such as nickel, nickel on kieselguhr, copper chromite, palladium on alumina, or cobalt plus zirconia or kieselguhr. The hydrogenation is preferably carried out in the presence of a solvent such as methyl cyclohexane, toluene, p-methane, etc., utilizing pressures ranging from 500 to 10,000 psi and a temperature of 150° to 300° C. Useful hydrogenated polyterpenes include those having a melt index of 8-15 g/10 min. at 190° C. An example of a commercially available hygrogenated polyterpene resin is Exxelor PA 609A from Exxon Mobil. This resin is identified as having a melt index of 11 g/10 min. (ASTM D 1238) and a density of 0.975 g/cm³ (ASTM D1505).

The blend of polypropylene resin and polyterpene resin is comprised of about 50% to about 80% by weight of polypropylene resin and about 20% to about 50% of polyterpene resin. In one embodiment, the blend comprises about 50% to about 60% by weight of polypropylene resin and about 40% to about 50% of polyterpene resin.

In addition to the high melt flow polypropylene resin and the polyterpene resin, the core layer may also contain other film forming polymeric resins in a lesser amount, generally about 0 to 20% by weight based on the total weight of the core layer. In one embodiment, the core layer contains about 0 to 15% by weight, and in another embodiment, about 4.5% by weight based on the total weight of the core layer. Such polymeric resins include high density polyethylene, a copolymer of ethylene and propylene, a polystyrene, a polyamide, a polyester, a polyester copolymer, a polycarbonate, a cyclic olefin copolymer, a cyclic olefin copolymer, or a mixture of two or more thereof.

In one embodiment, the core layer of the multilayer film comprises a medium impact copolymer polypropylene in addition to the high melt flow polypropylene resin and polyterpene resin blend. The medium impact copolymer generally are made by incorporating a rubbery material, ethylene-propylene rubber in the reactor with polypropylene. The ethylene-propylene rubber is an elastomer, made by the copolymerization of ethylene and propylene and typically contains 25% to 90% ethylene. Commercially available medium impact copolymers include Escorene PP7032, having a melt index of 4.5 g/10 min and a density of 0.90 g/cc, Escorene PP7033, having a melt index of 8 g/10 min and a density of 0.90 g/cc, and Escorene PD7623. E1 having a melt index of 7 g/10 min from ExxonMobil.

Various nucleating agents and pigments can be incorporated into the film core formulations of the present invention. The amount of nucleating agent added should be an amount sufficient to provide the desired modification of the crystal structure while not having an adverse effect on the desired properties of the film. It is generally desired to utilize a nucleating agent to modify the crystal structure and provide a large number of considerably smaller crystals or spherulites to improve the transparency (clarity), and stiffness, and the die-cuttability of the film. Nucleating agents that have been used for polymer films include mineral nucleating agents and organic nucleating agents. Examples of mineral nucleating agents include carbon black, silica, kaolin and talc. Among the organic nucleating agents that have been used in polyolefin films include salts of aliphatic mono-basic or di-basic acids or arylalkyl acids such as sodium succinate, sodium glutarate, sodium caproate, sodium 4-methylvalerate, aluminum phenyl acetate, and sodium cinnamate. Alkali metal and aluminum salts of aromatic and alicyclic carboxylic acids such as aluminum benzoate, sodium or potassium benzoate, sodium beta-naphtholate, lithium benzoate and aluminum tertiary-butyl benzoate also are useful organic nucleating agents. Substituted sorbitol derivatives such as bis(benzylidene) and bis(alkylbenzilidine) sorbitols wherein the alkyl groups contain from about 2 to about 18 carbon atoms are useful nucleating agents. More particularly, sorbitol derivatives such as 1,3,2,4-dibenzylidene sorbitol, 1,3,2,4-di-para-methylbenzylidne sorbitol, and 1,3,2,4-di-para-methylbenzylidene sorbitol are effective nucleating agents for polypropylenes. Useful nucleating agents are commercially available from a number of sources. Millad 8C-41-10, Millad 3988 and Millad 3905 are sorbitol nucleating agents from Milliken Chemical Co.

A particularly useful nucleating agent is a complex organophisphite compound commercially available under the trade name ADK Stabilizer NA-21 from Amfine Chemical Corporation. This compound is identified as aluminum, hydroxybis [2,4,8,10-tetrakis (1,1-dimethylethyl)-6-hydroxy-12H-dibenzo[d,g][1,3,2] dioxaphoshocin 6-oxidato].

The core layer 110 may include one or more pigments. The pigments that may be used include titanium dioxide. In one embodiment, a concentrate containing the pigment and a resin carrier is added to the mixture used to extrude the core layer. The concentrate may contain about 20% to about 80% by weight pigment, and about 80% to about 20% by weight resin carrier. The resin carrier may be any thermoplastic polymer having a melting point or glass transition temperature in the range of about 90° F. (32.2° C.) to about 250° F. (121.1° C.). Examples include polyethylene, polypropylene, polystyrene, rubber modified polystyrene, ABS, polymethyl methacrylate, polycarbonate, and the like. In one embodiment, a titanium dioxide concentrate is used which is comprised of a blend of about 20% to about 50% by weight linear low density polyethylene and about 50% to about 80% by weight titanium dioxide. An example of a commercially available pigment concentrate that may be used is available from Ampacet Corp. under the tradename Ampacet 110069. Another example of a commercially available pigment concentrate that can be used is available from A. Schulman Inc. under the tradename Polybatch P8555-SD, which is identified as a white color concentrate having a titanium dioxide concentration of 50% by weight in a polypropylene homopolymer carrier resin. The concentration of pigment in the core layer 110 may be up to about 30% by weight based on the weight of the core layer, and in any embodiment in the range of about 1% to about 20% by weight, and in one embodiment about 1 to about 15% by weight.

In one embodiment, the core layer comprises about 45% to about 70% by weight of polypropylene homopolymer, about 15% to about 40% by weight of polyterpene resin, about 5% to about 15% by weight of pigment, and about 2% to about 15% by weight of a low density polyethylene, based on the total weight of the core layer.

In one embodiment, the core layer comprises about 45% by weight of nucleated polypropylene homopolymer, about 40% by weight polyterpene resin, about 10.5% titanium dioxide, and about 4.5% of a low density polyethylene, based on the total weight of the core layer.

In another embodiment, the core layer comprises about 45% by weight of nucleated polypropylene homopolymer, about 40% by weight polyterpene resin, and about 15% of a low density polyethylene, based on the total weight of the core layer.

Skin Layer

In one embodiment, skin layer 120 may be comprised of a thermoplastic copolymer or terpolymer derived from ethylene or propylene and a functional monomer selected from alkyl acrylate, acrylic acid, alkyl acrylic acid, vinyl acetate and combinations of two or more thereof. In one embodiment, the functional monomer is selected from alkyl acrylate, acrylic acid, alkyl acrylic acid, and combinations of two or more thereof. The alkyl groups in the alkyl acrylates and the alkyl acrylic acids typically contain 1 to about 8 carbon atoms, and in one embodiment 1 to about 2 carbon atoms. The functional monomer(s) component of the copolymer or terpolymer may range from about 1 to about 15 mole percent, and in one embodiment about 1 to about 10 mole percent of the copolymer or terpolymer molecule. Examples include: ethylene/vinyl acetate copolymers; ethylene/methyl acrylate copolymers; ethylene/ethylacrylate copolymers; ethylene/butyl acrylate copolymers; ethylene/methacrylic acid copolymers; ethylene/acrylic acid copolymers; ethylene/methacrylic acid copolymers containing sodium or zinc (also referred to as ionomers); acid-, anhydride- or acrylate-modified ethylene/vinyl acetate copolymers; acid-or anhydride-modified ethylene/acrylate copolymers; anhydride-modified low density polyethylenes; anhydride-modified linear low density polyethylene, and mixtures of two or more thereof. In one embodiment, ethylene/vinyl acetate copolymers that are particularly useful include those with a vinyl acetate content of at least about 10% by weight, and in one embodiment about 18% to about 25% by weight. Examples of commercially available copolymers and terpolymers that can be used include the ethylene/vinyl acetate copolymers available from AT Plastics under the tradename EVA 1821. These copolymers and terpolymers may be present in the skin layer 120 at concentrations of up to about 50% by weight, and in one embodiment about 10 to about 35% by weight, and in one embodiment about 50% by weight.

The skin layer 120 may be further comprised of an additional thermoplastic polymeric material. This polymeric material may be a high density polyethylene, polystyrene, rubber modified polystyrene, acrylonitrile butadiene styrene (ABS), polypropylene, polyvinylidene fluoride, polyester, cylic olefin copolymer, and mixtures of two or more thereof. An example of a commercially available material is Equistar H6012 which is identified as a high density polyethylene. In one embodiment, the polymeric material comprises a polyterpene resin. Such polyterpene resins are described above with reference to the core layer. The polymeric material may be present in layer 120 at a concentration of about 25 to about 100 percent by weight, and in one embodiment about 60 to about 95 percent by weight.

In one embodiment, the skin layer 120 comprises a blend of a polypropylene homopolymer and a filler material. The polypropylene homopolymers useful for the skin layer are those described above with reference to the core layer. Particularly useful in the skin layer are nucleated polypropylene homopolymers. The fillers that can be used include calcium carbonate and talc. In one embodiment, the filler is added to the skin layer material in the form of a concentrate containing the filler and a resin carrier. The concentrate may contain, for example, about 20% to about 80% by weight filler, and about 20% to about 80% by weight resin carrier. The resin carrier can be any thermoplastic polymer having a melting point in the range of about 100° C. to about 265° C. Examples include polyethylene, polypropylene, polybutylene, polyester, nylon, and the like. Also included are thermoplastic copolymers such as ethylene methylacrylate, and the like. In one embodiment, a calcium carbonate concentrate is used that is comprised of a blend of about 50% to about 80% by weight polypropylene and about 20% to about 50% by weight calcium carbonate. An example of a commercially available filler concentrate that can be used is available from A. Schulman Inc. under the tradename PF 920, which is identified as a calcium carbonate concentrate having a calcium carbonate concentration of 40% by weight in a polypropylene homopolymer carrier resin. Another example is Ampacet 101087 which is a product of Ampacet Corporation identified as a calcium carbonate concentrate containing 70% by weight calcium carbonate and 30% by weight ethylene methylacrylate. The concentration of filler in the skin layer 120 can be up to about 40% by weight, and when used is generally in the range of about 10% to about 40% by weight, and in one embodiment about 10% to about 35% by weight.

Skin layer 120 may also be comprised of a polyethylene having a density of 0.940g/cm³ or less. Such polyethylenes generally are referred to in the art as low density or medium density polyethylenes, and these polyethylene homopolymers can be prepared by techniques well known to those skilled in the art including high pressure, free radical catalyzed processes and processes using metallocene catalysts. Low density polyethylenes and metallocene catalyzed processes for preparing such polyethylenes are described in U.S. Pat. Nos. 5,358,792; 5,462,809; 5,468,440; 5,475,075; and 5,530,054. Each of these patent is hereby incorporated by reference for its disclosure of metallocene catalysts, polyethylenes, and methods for preparing polyethylenes. Metallocene-catalyzed polyethylenes generally have a density of from about 0.850 to about 0.925 g/cm³, and more often from about 0.860 to about 0.920 g/cm³. Examples of commercially available metallocene catalyzed LLDPE include Exact 4151, Exact 0210, Exact 0230, Exact 8203 and Exact 8210 from ExxonMobil and Dow Affinity PT 1450 and Affinity 8185 from Dow Chemical Company.

In one embodiment, the skin layer 120 comprises about 45% to about 75% by weight of a polypropylene homopolymer, about 5% to about 35% by weight of a filler material such as calcium carbonate, and about 5% to about 45% by weight of a low density polyethylene, based on the total weight of the skin layer. The polypropylene homopolymer may comprise a nucleated polypropylene homopolymer having a melt flow rate of at least 8 g/10 min., and in one embodiment, at least about 10 g/10 min, and in one embodiment, about 20 g/10 min.

Skin layer 120 may be surface treated to enhance the printability of the surface. For example, the outer surface of skin layer 120 may be exposed to an electron discharge treatment, e.g., corona treatment. Other surface treatments to enhance the printability of the skin layer are well known.

Tie Layer

The multilayer film of the present invention at least one tie layer 140 positioned between the core layer and the heat activatable layer. The tie layer may comprise any polymeric material that improves the adhesion of the heat activatable layer to the core layer. The film forming thermoplastic polymeric materials that can be used include polypropylene, copolymers of ethylene and propylene, medium density polyethylene (density of about 0.924 to about 0.939 g/cc), terpolymers of ethylene, vinyl acetate and maleic anhydride, and terpolymers of ethylene, vinyl acetate and acrylic acid. In one embodiment, the tie layer comprises a medium impact copolymer polypropylene. An example of a commercially available medium impact copolymer that may be used is Escorene PD7623. E1 from ExxonMobil, identified as having a melt index of 7 g/10 min.

In one embodiment, the tie layer comprises a blend of a propylene homopolymer and a low density polyethylene. The low density polyethylene may comprise a metallocene catalyzed linear low density polyethylene as described above with reference to the skin layer. The tie layer may comprise about 55% to about 80% by weight of a propylene homopolymer and about 20% to about 45% by weight of a low density polyethylene, based on the total weight of the tie layer. In one embodiment, the low density polyethylene has a melt index (MI) of greater than 2 g/10 min., and in one embodiment an Ml of greater than 5 g/10 min.

Heat Activatable Layer

The heat activatable layer 130 is a layer of material that is activated by heat during the molding process to improve the bonding of the label to a plastic article in the molding process. Material for the heat-activatable layer may comprise a thermoplastic film material. Such materials include, but are not limited, to the film-forming materials used alone or in combination such as polyolefin, (linear or branched), metallocene catalyzed polyolefins, syndiotactic polystyrenes, syndiotactic polypropylenes, cyclic polyolefins, polyacrylates, polyethylene ethyl acrylate, polyethylene methyl acrylate, acrylonitrile butadiene styrene polymer, ethylene-vinyl alcohol copolymer, ethylene-vinyl acetate copolymers, polyamides such as nylon, polystyrenes, polyurethanes, polysulfones, polyvinylidine chlorides, polycarbonates, styrene maleic anhydride polymers, styrene acrylonitrile polymers, monomers based on sodium or zinc salts or ethylene/methacrylate acid, ethylene methyl acrylate, ethylene acrylic acid and ethylene ethyl acrylate. Also included are polymers and copolymers of olefin monomers having, for example, 2 to about 12 carbon atoms, and in one embodiment 2 to about 8 carbon atoms. These include the polymers of α-olefins from 2 to about 4 carbon atoms per molecule. These include polyethylene, polypropylene, poly-1-butene, etc.

In one embodiment, the heat activatable layer comprises a low density polyethylene. Such low density polyethylenes are described above with reference to the skin layer 120. Particularly useful low density polyethylene resins include plastomers that are any of a number of ethylene, α-olefin copolymers. This ethylene copolymer has a density in the range of from 0.850 to 0.925 g/cc, or from 0.860 to 0.910 g/cc or from 0.880 to 0.910 g/cc. The α-olefin used to make the ethylene α-olefin copolymer is selected from one or more of propylene, butene-1, 4-methyl-1-pentene, pentene-1, hexene-1, octene-1, decene-1 and mixtures thereof. Such combinations include, but are not limited to, copolymers such as ethylene/propylene; ethylene/butene-1; ethylene/hexene-1; ethylene/pentene-1; ethylene/4-methyl-1-pentene; ethyene/octene-1; ethylene/propylene/butene-1; ethylene/propylene/hexene-1; ethylene/propylene/pentene-1; ethylene/propylene/octene-1; and the like. Examples of commercially available plastomers include Exact 4151, Exact 0210, Exact 0230, Exact 8210 and Exact 8203 from ExxonMobil and Affinity PT 1450 and Affinity 8185 from Dow Chemical Company.

Also, the heat activatable layer may contain antiblock additives such as silica, diatomaceous earth, synthetic silica, glass spheres and ceramic particles. Polymeric particles such as polymethyl methacrylate fine particles, crosslinked polymethyl methacrylate fine particles, crosslinked polystyrene fine particles, silicone resin fine particles and polytetrafluoroethylene fine particles may be used as the antiblock additive. A particularly useful antiblock additive comprises polymeric particles having a particle size of about 5 microns in a resin carrier. The resin carrier may comprise a low density polyethylene. A commercially available antiblock additive useful in the present invention is Seablock-4, also referred to as Ampacet 400880 from Ampacet Corporation. The amount of antiblock additive that is used may be varied for particular formulations and processing conditions. In one embodiment, the amount that is used may range up to about 0.5% by weight, and in one embodiment, from about 0.01% to about 0.35%, and in one embodiment about 0.3% by weight.

The heat activatable layer may also contain a slip agent. The slip agents that are particularly useful include non-migratory slip agents. A commercially available non-migratory slip agent is Ampacet 101501 from Ampacet Corporation, identified as a concentrate containing 10% by weight of a slip agent dispersed in a low density polyethylene. The amount of slip agent that is used may be varied for particular formulations and processing conditions. In one embodiment, the amount that is used may range up to about 1.5% by weight, and in one embodiment, from about 0.01% to about 1.2%, and in one embodiment about 1.0% by weight.

The heat activatable layer may also contain an antistatic additive. These additive as used to dissipate static electricity charges. The antistatic additives that are particularly useful include non-migratory antistats. Charge dissipation for such non-migratory anitstats is not dependent on humidity for functionality. Rather charge dissipation occurs by an electron tunneling mechanism. Commercially available non-migratory antistatic additives include Ampacet 101710 from Ampacet Corporation, identified as a concentrate containing 50% by weight of an antistatic additive dispersed in a low density polyethylene. The amount of antistatic additive that is used may be varied for particular formulations and processing conditions. In one embodiment, the amount that is used may range up to about 10% by weight (active ingredient), and in one embodiment, from about 0.01% to about 15%, and in one embodiment about 5.0% by weight based on the total weight of the heat activatable layer.

The hot-stretching and annealing steps used in making the inventive film enhance the physical properties of the film. Hot-stretching is performed at a temperature above the expected service temperature of the label and provides the film with a machine direction orientation. The density of the film is reduced during this step by about 5% to about 25%, and in one embodiment about 15% to about 20%. The film is annealed at a temperature above the expected service temperature of the label to reduce shrinking, relaxing or distortion of the film which may interfere with the in-mold labeling process. During the hot-stretching and annealing steps, the extrudate is advanced through a series of relatively hot and cool rolls which contact the extrudate and impart heat to the extrudate or remove heat from it under time-temperature-direction conditions established by line speed, temperature, roll size, and side of contact. The direction at which the film advances through the rolls is the direction at which the film is hot-stretched and is oriented. This direction is sometimes referred to as the “machine direction.” The term “cross direction” is used herein to refer to the direction going across the film at an angle of 90° from the machine direction.

During the hot-stretching step, the film is stretched and this stretching causes voids to form adjacent to or around the particulate solids. The solids act as “seeds” for the voids. The degree of stretching is controlled to provide the density reduction of about 5% to about 25%, as indicated above. While not wishing to be bound by theory, it is believed that this controlled stretching and void formation followed by the above-indicated annealing step is responsible for the relatively smooth print surfaces that are achieved with the inventive labels.

The inventive multilayered film may be co-extruded, hot-stretched and annealed using the processing line depicted in FIG. 2. The processing line depicted in FIG. 2 will be described with reference to the film 100 illustrated in FIG. 1. The processing line includes extruders 200, 210, 220 and 230, feed block 240 and die 250. Extruder 200 is used for extruding heat activatable layer 130. Extruder 210 is used for extruding tie layer 140. Extruder 220 is used for extruding core layer 110. Extruder 230 is used for extruding skin layer 120. The extrudate from the extruder 200 is advanced to the feed block 240 while at a temperature in the range of about 390° F. (198.9° C.) to about 470° F. (243.3° C.), and in one embodiment about 400° F. (204.4° C.). The extrudate from the extruder 200 is advanced to the feed block 240 while at a temperature in the range of about 400° F. (204.4° C.) to about 470° F. (243.3° C.), and in one embodiment about 430° F. (221.1° C.). The extrudate from the extruder 200 is advanced to the feed block 240 while at a temperature in the range of about 390° F. (198.9° C.) to about 470° F. (243.3° C.), and in one embodiment about 400° F. (204.4° C.). The extrudate from the extruder 200 is advanced to the feed block 240 while at a temperature in the range of about 390° F. (198.9° C.) to about 470° F (243.3° C.), and in one embodiment about 400° F. (204.4° C.). The extrudates from each of the extruders 200, 210, 220 and 230 are combined in feedblock 240 and extruded through die 250 to form film extrudate 255. Feedblock 240 and die 250 are operated at a temperature in the range of about 400° F. (204.4° C.) to about 470° F. (243.3° C.), and in one embodiment about 435° F. (223.9° C.). The film extrudate 255 extruded from die 250 may have a film thickness of about 10 to about 20 mils, and in one embodiment about 12 to about 15 mils. Air knife 260 is used to adhere film extrudate 255 to cast roll 270. The film extrudate 255 is advanced from cast roll 270 to cast roll 280, over cast roll 280, between cast roll 280 and cast nip roll 290, and then over guide rolls 300, 320, 330, 340 and 350 to machine direction orientation unit 360. Cast roll 270 is operated at a temperature of about 135° F. (57.2° C.) to about 185° F. (85° C), and in one embodiment about 160° F. (71.1° C.). Cast roll 280 is operated a temperature of about 100° F. (37.8° C.) to about 150° F. (65.6° C.), and in one embodiment about 120° F. (48.9° C.). The film is advanced over cast rolls 270 and 280 at a rate of about 40 to about 110 feet per minute, and in one embodiment about 85 feet per minute. The thickness of the film 255 is monitored using film thickness measuring device 310 as the film advances from guide roll 300 to guide roll 320. In the machine direction orientation unit 360, the film advances from pre-heat roll 370 to pre-heat roll 380. Pre-heat roll 370 is operated at a temperature of about 130° F. (54.4° C.) to about 170° F. (76.7° C.), and in one embodiment about 150° F. (65.6° C.). The film is advanced over pre-heat roll 370 at a rate of about 40 to about 110 feet per minute, and in one embodiment at about 86 feet per minute. Pre-heat roll 380 is operated at a temperature of about 145° F. (62.8° C.) to about 185° F. (85° C.), and in one embodiment about 165° F. (73.9° C.). The film advances over pre-heat roll 380 at a rate of about 40 to about 120 feet per minute, and in one embodiment about 89 feet per minute. The film is advanced from pre-heat roll 380, between draw nip roll 385 and draw roll 390, over draw roll 390, between draw nip roll 395 and draw roll 400, over draw roll 400 to preheat roll 405. Draw roll 390 is operated at a temperature of about 160° F. (71.1° C.) to about 200° F. (93.3° C.), and in one embodiment at about 180° F. (82.2° C.) The film is advanced over draw roll 390 at a rate of about 40 to about 130 feet per minute, and in one embodiment at about 89 feet per minute. Draw roll 400 is operated at a temperature of about 170° F. (76.7° C.) to about 220° F. (104.4° C.), and in one embodiment at about 190° F. (87.8° C.). The film is advanced over draw roll 400 at a rate of about 300 to about 600 feet per minute, and in one embodiment at about 402 feet per minute. The film advances from pre-heat roll 405 to pre-heat roll 410. Pre-heat roll 405 is operated at a temperature of about 190° F. (87.8° C.) to about 230° F. (110° C.), and in one embodiment about 210° F. (98.9° C.) Pre-heat roll 410 is operated at a temperature of about 210° F. (98.9° C.) to about 250° F. (121.1° C.), and in one embodiment about 230° F. (110° C.). The film is advanced from pre-heat roll 410, between draw nip roll 415 and draw roll 420, over draw roll 420, between draw nip roll 425 and draw roll 430, over draw roll 430 and then to guide roll 435. Draw roll 420 is operated at a temperature of about 240° F. (115.6° C.) to about 280° F. (137.8° C.), and in one embodiment at about 260° F. (126.7° C.). Draw roll 430 is operated at a temperature of about 230° F. (110° C.) to about 270° F. (132.2° C.), and in one embodiment at about 250° F. (121.1° C.). The effect of advancing the film from draw roll 390 to draw roll 400 and from draw roll 420 to draw roll 430 is to stretch the film sufficiently to provide the film with a machine direction orientation. The stretch ratio may range from about 5.0 to about 5.9, and in one embodiment at about 5.75. The film is then advanced from annealing roll 440 to annealing roll 450. Annealing roll 440 is operated at a temperature of about 250° F. (121.1° C.) to about 290° F. (143.3° C.), and in one embodiment at about 270° F. (132.2° C.). Annealing roll 450 is operated at a temperature of about 230° F. (110° C.) to about 270° F. (132.2° C.), and in one embodiment at about 250° F. (121.1° C.). The film is advanced over annealing rolls 440 and 450 at a rate of about 285 to about 400 feet per minute, and in one embodiment at about 345 feet per minute. The film is then advanced from annealing roll 450 to cooling nip roll 460, between cooling nip roll 460 and cooling roll 470, over cooling roll 470 to cooling roll 480, over cooling roll 480 to guide roll 490, over guide roll 490 to guide roll 510. Cooling roll 470 is operated at a temperature of about 150° F. (65.6° C.) to about 250° F. (121.1° C.), and in one embodiment at about 200° F. (93.3° C.). Cooling roll 480 is operated at a temperature of about 140° F. (60° C.) to about 200° F. (93.3° C.), and in one embodiment at about 160° F. (71.1° C.). The film is advanced over cooling rolls 470 and 480 at a rate of about 300 to about 600 feet per minute, and in one embodiment about 345 feet per minute. The film is advanced from guide roll 510 to guide roll 520, then over guide roll 520 to corona treating station 540. The thickness of the film is monitored using film thickness measuring device 530 which is positioned between guide roll 510 and guide roll 520. In the corona treating station, both sides of the film are treated to increase surface energy. The surface energy on the surface of the skin layer 120 is increased sufficiently to enhance adhesion of ink to the surface during subsequent printing operations. The film is advanced from the corona treating station 540 through nip rolls 550 to cooling nip roll 560, between cooling nip roll 560 and cooling roll 570, over cooling roll 570 to roll 580 where it is wound on the roll for subsequent processing. The film is advanced through corona treating station at a rate of about 300 to about 600 feet per minute, and in one embodiment about 345 feet per minute.

The hot-stretching and annealing of the film increases stiffness of the film in the machine direction but leaves the film relatively flexible in the cross direction. This process may be referred to as uniaxial stretching. In one embodiment, it is contemplated to use unbalanced or balanced biaxial stretching of the film to achieve a satisfactory stiffness differential between the machine and cross directions, with the degrees of stretching and stiffness in the machine direction exceeding those in the cross direction. Whether the stretching is biaxial or uniaxial, that is, whether there is little (relatively) or no stretching in the cross direction, the degree of stretching in the machine direction exceeds that in the cross direction so that the film is substantially stiffened in the machine direction and remains relatively flexible in the cross direction. Therefore the film, whether uniaxially or biaxially stretched, may be referred to as having a machine direction stiffness differential.

Uniaxial hot-stretching and annealing are also important to the development of in-mold label film tensile properties necessary to withstand the mechanical and thermal stresses of conventional printing techniques of the type used in processing paper labels.

The inventive films are characterized by a machine direction shrinkage after hot-stretching and annealing of less than about 2%, and in one embodiment less than about 1.5%, and in one embodiment less than about 1%, and in one embodiment less than about 0.75%, and in one embodiment in the range of about 0.1 to about 1%, and in one embodiment in the range of about 0.25 to about 0.75%. Shrinkage is determined using test method ASTM D 2739-96.

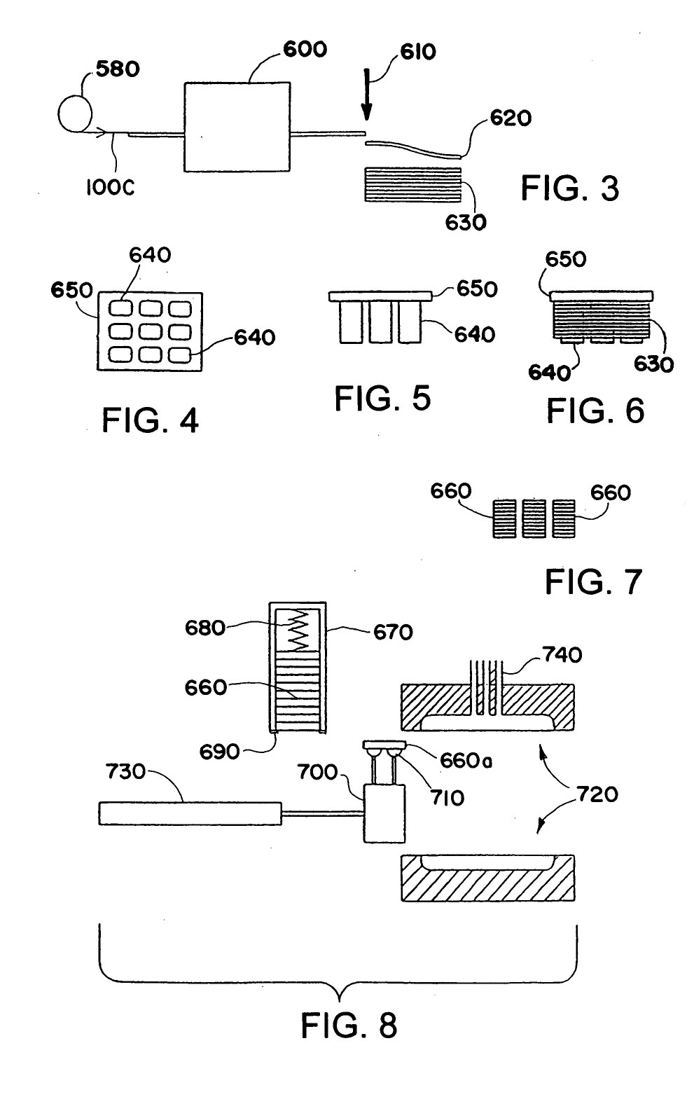

As schematically illustrated in FIG. 3, the stretched and annealed film 100, which may be supplied in the form of self-wound roll 560, may be printed or decorated in a printing press 600 in which the film is subjected to mechanical and thermal stress incident to the printing itself and to the drying of the ink by exposure to heat as such or by exposure to ultraviolet radiation which tends to also generate infrared radiation. Print indicia may be applied to skin layer 120.

Following printing and drying, the film may be sheeted and stacked in a manner similar to that known for the sheeting of paper-backed label stock. Cutting is indicated by arrow 610 in the drawings. The severed sheets 620 are stacked to form stack 630. The stack may contain, for example, 100 or 200 sheets. For clarity of illustration, in the drawing the thickness of the sheets is greatly exaggerated and the stack 630 is therefore shown as made up of only a relatively small number of sheets. Each sheet in the stack is intended to provide material for several individual labels to be die-cut from the sheeted material. In the particular example described, nine labels are die-cut from each sheet. The sheets in the stack are accurately registered with each other so that the labels to be cut from the sheet will be formed in correct registration to the printing that appears on their face according to the pattern printed by the press 600.

If the film is too limp, accurate stacking is prevented due to the inability to guidingly control positioning of a limp sheet by means of belts, guideways, stops or similar guiding mechanisms (not shown) with any degree of accuracy. The stiffening of the inventive film by hot-stretching to desired stiffnesses, as discussed above, allows for accurate stacking to be achieved. In one embodiment, the bending stiffness in the machine direction (MD) is at least 100 nM, and in one embodiment at least about 150 nM. The cross direction bending stiffness in one embodiment is at least 50 nM, and in one embodiment at least 70 nM.

Accurate stacking and subsequent handling of the sheets or labels formed therefrom is also impeded if static charges are present on the sheets or labels. The antistatic additives discussed above act to remove or dissipate static charges.

Individual labels are formed in a known manner by hollow punches or cutting dies 640 carried on a head 650, seen in bottom plan view in FIG. 4 and in side elevation in FIGS. 5 and 6. The cutting dies punch out the labels from the stack 630, producing in each cutting cycle a number of stacks 660 of individual labels shown in FIG. 7. In the particular example described, nine stacks of individual labels are produced in each cutting cycle.

Alternatively, following printing and drying, the stock may be fed into a rotary steel die (not shown) at the end of the printing press line and cut into labels. As the cut labels and surrounding matrix of waste material exit from the rotary steel die, the matrix is pulled away at an angle from the labels which are sufficiently stiff to continue their forward travel into a nip of a pair of feed belts (not shown) for collection into stacks 660. Thus, the machine direction stiffness is utilized in a direct label cutting and separating process which eliminates the cutting step at 610 as well as the other steps described with respect to FIGS. 4, 5 and 6.

The stacks 660 of individual labels are stabilized by suitable wrapping or packaging (not shown) in a manner similar to that previously used with paper-backed labels. The stabilized stacks 660 are then moved or transported to the site where the blow-molded, injection molded or injection-blown containers are being manufactured, which often is at a different place than the site of label manufacture.

At the site of container manufacture, stacks 660 of individual labels are loaded in dispensing magazine 670 as schematically illustrated in FIG. 8. For example, the labels may be advanced to the front of the magazine by a spring 680, and may be lightly retained for pick-off by mechanically retracting retainer fingers 690. A robotic label feed head 700 carries vacuum cups 710 adapted to be advanced by a mechanism (not shown) internal to the head 700 to pick off the front label 660a in the stack 660. The vacuum cups are retracted for translating movement of the head and the single picked-off label 660a into the opened mold 720. Movement of the head 700 is actuated by translating cylinder 730. The vacuum cups 710 are advanced again to apply the picked-off label 660a to the interior surface of the mold and release it. The label may then be held accurately in position within the mold by vacuum applied to the mold wall through vacuum lines 740 while the label feed head 700 is retracted. The vacuum line outlets to the interior of the mold may be flush with the interior surface of the mold, as shown, so that the label occupies part of the mold cavity proper. In other words, there is no recess on the interior mold surface to accommodate the label.

A hot workpiece or parison (not shown) of high density polyethylene or similar thermoplastic resin is fed into the mold 720, the mold is closed, and the parison is expanded in a known manner to complete the formation of the molded container. The hot-stretching and annealing temperatures used in making the inventive film exceed the service temperature in the mold. To assure a uniform joining of the label to the container, it is desirable that the softening temperature of the in-mold label film be close to the service temperature. If the label is on, not in, the interior surface of the mold, the label becomes embedded in the workpiece to which it is adhered, thus advantageously providing an inset label that is flush with the container surface and that replaces and therefore saves a portion of the charge for the molded workpiece or container without diminishing the structural integrity of the workpiece to any detected degree.

### EXAMPLES

The following examples are provided to further disclose the invention. The ingredients used are listed below.

TABLE 1

| Trade Name | Description |
|---|---|
| Ampacet 101087 | 70% loaded CaCO₃ in EMA (3 micron particles) |
| Ampacet 101501 | Non-migratory slip (10% active) |
| Ampacet 101710 | Non-migratory anti-stat agent (50% active) |
| Ampacet 110069 | 70% loaded TiO₂ in LLDPE (rutile) |
| Ampacet 400880 | Anti-block (3% loaded) Seablock-4 (5 micron particles) |
| DuPont Bynel E418 | Anhydride modified EVA (0.95 g/cc density, 165° F. Mp) |
| Escorene PD7623.E1 | Medium-impact copolymer polypropylene |
| Exact 4151 | Metallocene LLDPE (plastomer) 2.2 MI, 192° F. Mp, 0.895 g/cc density |
| Exxcelor PA609A | Hydrogenated polyterpene |
| Exact 0210 | Metallocene LLDPE (plastomer) 10 MI, 205° F. Mp, 0.902 g/cc density |
| Exact 0230 | Metallocene LLDPE (plastomer) 30 MI, 203° F. Mp, 0.902 g/cc density |
| Exact 8203 | Metallocene LLDPE (plastomer) 3 MI, 205° F. Mp, 0.882 g/cc density |
| Exact 8210 | Metallocene LLDPE (plastomer) 10 MI, 165° F. Mp, 0.882 g/cc density |
| Affinity PT 1450 | Metallocene LLDPE (plastomer) 7.5 MI, 208° F. Mp, 0.902 g/cc density |
| Huntsman P4G4K-038 | Homopolymer polypropylene, nucleated, clarified (12 MFR) |
| Huntsman P4C5K-123A | Homopolymer polypropylene, nucleated, clarified with anti-stat (20 MFR) |
| Ticona Topas 8007-D61 | Cyclic olefin copolymer |

A multilayered film corresponding to film 100 in FIG. 1 and having a thickness of 4.5 mils is prepared by co-extruding, stretching and annealing the following layers (all percentages by weight):

TABLE 2

```
Print Skin
60% Huntsman P4G4K-038
40% Ampacet 101087
Core
50% Huntsman P4G4K-038
35% ExxonMobil Exxcelor PA609A
15% Ampacet 110069
Tie Layer
100% ExxonMobil Escorene PD7623.E1
Heat Activatable Layer
83% Dow Affinity PT1450
10% Ampacet 101501
  5% Ampacet 400880
  2% Ampacet 101710
```

The multilayered film of Example 1 is co-extruded, hot stretched and annealed using the line illustrated in FIG. 2.

### EXAMPLES 2-6

The multilayered films of Examples 2-6 are prepared substantially in accordance with the film of Example 1, with the exception that the individual layers are made of the following ingredients:

TABLE 3

| | | | | Heat Activatable |
|---|---|---|---|---|
| Example | Skin Layer | Core Layer | Tie Layer | Layer |
| 2 | 40% P4G4K-038 | 50% P4G4K-038 | 100% PD7623.E1 | 83% Affinity PT1450 |
| | 40% 101087 | 18% PA609A | | 10% 101501 |
| | 20% PD7623.E1 | 17% PD7623.E1 | | 5% 400880 |
| | | 15% 110069 | | 2% 101710 |
| 3 | 50% P4C5K-123A | 70% P4C5K-123A | 65% P4C5K-123A | 78% Exact 4151 |
| | 35% Exact 4151 | 15% 110069 | 35% Exact 4151 | 10% 101501 |
| | 15% 101087 | 15% PA609A | | 10% 400880 |
| | | | | 2% 101710 |
| 4 | 50% P4C5K-123A | 45% P4C5K-123A | 65% P4C5K-123A | 78% Exact 4151 |
| | 35% Exact 4151 | 25% PA609A | 35% Exact 4151 | 10% 101501 |
| | 15% 101087 | 15% 110069 | | 10% 400880 |
| | | 15% PD7623.E1 | | 2% 101710 |
| 5 | 65% P4C5K-123A | 50% P4C5K-123A | 75% P4C5K-123A | 78% Exact 4151 |
| | 25% 101087 | 25% PA609A | 25% Exact 4151 | 10% 101501 |
| | 10% Exact 4151 | 15% 110069 | | 10% 400880 |
| | | 10% PD7623.E1 | | 2% 101710 |
| 6 | 65% P4C5K-123A | 45% P4C5K-123A | 75% P4C5K-123A | 78% Exact 0230 |
| | 25% 101087 | 40% PA609A | 25% Exact 4151 | 10% 101501 |
| | 10% Exact 4151 | 15% 110069 | | 10% 400880 |
| | | | | 2% 101710 |
| 7 | 35% 101087 | 45% P4C5K-123A | 48% P4C5K-123A | 60% Exact 0230 |
| | 33% P4C5K-123A | 30% PA609A | 32% PA609A | 10% 400880 |
| | 22% PA609A | 15% 110069 | 20% Exact 0230 | 10% Bynel E418 |
| | 10% Exact 4151 | 10% Topas8006D61 | | 10% 101501 |
| | | | | 10% 101710 |
| 8 | 35% 101087 | 42.5% P4C5K-123A | 40% P4C5K-123A | 60% Exact 0210 |
| | 27.5% P4C5K-123A | 42.5% PA609A | 40% PA609A | 10% 400880 |
| | 27.5% PA609A | 15% 110069 | 20% Exact 0210 | 10% Bynel E418 |
| | 10% Exact 4151 | | | 10% 101501 |
| | | | | 10% 101710 |
| 9 | 55% P4C5K-123A | 45% P4C5K-123A | 40% P4C5K-123A | 70% Exact 8210 |
| | 35% 101087 | 40% PA609A | 40% PA609A | 10% 400880 |
| | 10% Exact 4151 | 15% 110069 | 20% Exact 8210 | 10% 101501 |
| | | | | 10% 101710 |
| 10 | 35% 101087 | 51% P4C5K-123A | 48% P4C5K-123A | 70% Exact 8203 |
| | 33% P4C5K-123A | 34% PA609A | 32% PA609A | 10% 400880 |
| | 22% PA609A | 15% 110069 | 20% Exact 8203 | 10% 101501 |
| | 10% Exact 4151 | | | 10% 101710 |
| 11 | 35% 101087 | 51% P4C5K-123A | 60% P4C5K-123A | 55% Exact 4151 |
| | 33% P4C5K-123A | 34% PA609A | 40% PA609A | 15% Bynel E418 |
| | 22% PA609A | 15% 110069 | | 10% 400880 |
| | 10% Exact 4151 | | | 10% 101501 |
| | | | | 10% 101710 |

The bending stiffness of films of Examples 1-6 were measured with a Lorentzen & Wettre Bending Resistance Tester. The Bending Resistance Tester measures the force necessary to deflect a rectangular test piece, clamped at one end, through a specified bending angle when the force is applied near to the free end of the test piece (ISO 2493). The stiffness in the machine direction and the cross direction for each film is given in Table 4. The stiffness given is normalized at a film thickness of 4.5 mil.

TABLE 4

| Example | MD Stiffness (mN) | CD Stiffness (mN) |
|---|---|---|
| 1 | 181.9 | 97.1 |
| 2 | 164.0 | 78.2 |
| 3 | 129.1 | 60.0 |
| 4 | 127.4 | 52.3 |
| 5 | 153.4 | 71.5 |
| 6 | 198.7 | 91.2 |

While the invention has been explained in relation to specific embodiments, it is to be understood that various modifications thereof will become apparent to those skilled in the art upon reading the specification. Therefore, it is to be understood that the invention disclosed herein is intended to cover such modifications as fall within the scope of the appended claims.

1. A multilayer film for use in making an in-mold label, comprising:
a core layer having an upper surface and a lower surface;
a skin layer overlying the upper surface of the core layer;
a heat activatable layer bonded to the lower surface of the core layer by a tie layer;
wherein the core layer comprises a blend of a propylene homopolymer and at least one polyterpene and wherein the multilayer film is oriented in the machine direction only and heat set.

2. The film of claim 1 wherein the polypropylene homopolymer has a melt flow rate of at least about 8 g/10 min.

3. The film of claim 1 wherein the polypropylene homopolymer has a melt flow rate of at least about 10 g/10 min.

4. The film of claim 1 wherein the polypropylene homopolymer has a melt flow rate of about 20 g/10 min.

5. The film of claim 1 wherein the polypropylene homopolymer comprises a nucleated polypropylene.

6. The film of claim 1 wherein the polyterpene resin is a hydrogenated polyterpene having a melt index of about 8 to about 15 g/10 min.

7. The film of claim 1 wherein the core layer further comprises a medium impact copolymer polypropylene.

8. The film of claim 1 wherein the core layer further comprises a cyclic olefin copolymer.

9. The film of claim 1 wherein the thickness of the core layer is about 40% to about 80% of the overall thickness of the multilayer film.

10. The film of claim 1 wherein the thickness of the heat activatable layer is about 10% to about 25% of the overall thickness of the multilayer film.

11. The film of claim 1 wherein the thickness of the heat activatable layer is about 20% of the overall thickness of the multilayer film.

12. The film of claim 1 wherein the blend of polypropylene homopolymer and polyterpene comprises about 50% to about 80% by weight of polypropylene homopolymer and about 20% to about 50% by weight of polyterpene, based on the weight of the polypropylene homopolymer and polyterpene.

13. The film of claim 1 wherein the core layer further comprises a metallocene catalyzed polyolefin resin.

14. The film of claim 1 wherein the core layer further comprises a pigment.

15. The film of claim 1 wherein the skin layer comprises a blend of a polypropylene homopolymer and a filler material.

16. The film of claim 15 wherein the skin layer further comprises a metallocene catalyzed polyethylene.

17. The film of claim 15 wherein the filler material comprises calcium carbonate

18. The film of claim 15 wherein the polyethylene has a density in the range of about 0.860 and 0.920 g/cm³.

19. The film of claim 15 wherein the polypropylene homopolymer has a melt flow rate of at least 8 g/10 min.

20. The film of claim 1 wherein the tie layer comprises a polypropylene homopolymer and a metallocene catalyzed polyethylene resin.

21. The film of claim 1 wherein the heat activatable layer comprises a metallocene catalyzed polyethylene resin.

22. The film of claim 21 further comprising an antiblock additive.

23. The film of claim 21 further comprising a non-migratory slip agent.

24. The film of claim 21 further comprising a non-migratory antistatic additive.

25. The film of claim 1 wherein the bending stiffness of the film in the machine direction is at least 100 nM.

26. The film of claim 1 wherein the bending stiffness of the film in the machine direction is at least 150 nM.

27. The film of claim 1 wherein the bending stiffness of the film in the cross direction is at least 50 nM.

28. The film of claim 1 wherein the bending stiffness of the film in the cross direction is at least 70 nM.

29. The film of claim 1 wherein print indicia is applied to the skin layer.
